(19) United States
(12) Patent Application Publication
(10) Pub. No.: US 2025/0145175 A1
(43) Pub. Date: May 8, 2025

(54) VEHICLE TRAVELING CONTROL SYSTEM

(71) Applicant: TOYOTA JIDOSHA KABUSHIKI KAISHA, Toyota-shi (JP)

(72) Inventor: Hiroto MURATA, Toyota-shi (JP)

(73) Assignee: TOYOTA JIDOSHA KABUSHIKI KAISHA, Toyota-shi (JP)

(21) Appl. No.: 18/815,044

(22) Filed: Aug. 26, 2024

(30) Foreign Application Priority Data
Nov. 2, 2023 (JP) 2023-188234

(51) Int. Cl. B60W 60/00; B60W 30/045

(52) U.S. Cl. CPC B60W 60/001; B60W 30/045

(57) ABSTRACT

A vehicle traveling control system installed on a vehicle and including a traveling control device configured to control traveling of the vehicle, wherein a traveling line, along which the vehicle is to travel when the vehicle turns a corner in a travel route, is determined based on specifications of the vehicle, and the traveling control device is configured to cause the vehicle to turn along the traveling line.

### REFERENCE TO RELATED APPLICATIONS

This application claims priority from Japanese Patent Application No. 2023-188234 filed on Nov. 2, 2023. The entire content of the priority application is incorporated herein by reference.

### TECHNICAL FIELD

The present disclosure relates to a vehicle traveling control system for controlling traveling of a vehicle, in particular, turning traveling of the vehicle.

### BACKGROUND ART

There is known a technique described in Japanese Patent Application Publication No. 2023-55228 (JP 2023-55228 A) regarding traveling control of a vehicle that travels without depending on a human operation (hereinafter, also referred to as an “autonomous traveling vehicle”). In this technique, nodes are set on a route on which the vehicle travels, and the vehicle travels so as to follow the nodes.

### SUMMARY

Traveling lines that the vehicles can travel differ depending on specifications of the vehicles. Specifically, for example, the traveling line when turning a corner differs depending on the length of the vehicle or the like. In the technique described in the above patent document, there is no description about a difference in the specifications of the vehicles, and the traveling control of the autonomous traveling vehicle becomes practical by considering the difference in the specifications of the vehicles. The present disclosure has been made in view of such circumstances, and an object thereof is to provide a highly practical vehicle traveling control system.

In one aspect of the present disclosure, a vehicle traveling control system is installed on a vehicle and includes a traveling control device configured to control traveling of the vehicle. A traveling line, along which the vehicle is to travel when the vehicle turns a corner in a travel route, is determined based on specifications of the vehicle, and the traveling control device is configured to cause the vehicle to turn along the traveling line.

According to the vehicle traveling control system of present disclosure (hereinafter abbreviated as the “present vehicle traveling control system” or the “present system” where appropriate), the vehicle can appropriately turn a corner in the travel route regardless of its own specifications.

### Various Forms

A traveling area in which the vehicle to which the present system is applied travels is, for example, an area in which passages through which the vehicle travels are arranged, such as a town or an enterprise space. For example, the travel route of the vehicle is set so as to go around some of the passages. The “traveling line” in the present system means, for example, a line along which a specific point of the vehicle (for example, the center of gravity point of the vehicle, the center point of the front end of the vehicle, or the like) moves, a trajectory drawn by the specific point, or the like in the travel route, and the traveling line along which the vehicle should travel can be considered as a traveling line serving as a target in traveling of the vehicle, that is, a target line.

The traveling line when the vehicle properly turns varies depending on the specifications of the vehicle. Here, the “specifications of the vehicle” include a size (length, width, and the like) of the vehicle, a wheelbase, a tread, an inner wheel difference between tracks followed by front and rear inner wheels in turning (hereinafter simply referred to as the “inner wheel difference” where appropriate), an outer wheel difference between tracks followed by front and rear outer wheels in turning (hereinafter simply referred to as the “outer wheel difference” where appropriate), an appropriate vehicle speed, a turning radius, and the like. The specifications of the vehicle on which the determination of the traveling line in turning is based preferably include, in particular, the turning radius. As the turning radius, an appropriate turning radius may be selected from various turning radii such as a minimum turning radius and a set appropriate turning radius. Depending on the specifications of the vehicle, more specifically, when the size of the vehicle is large, when the turning radius is large, or the like, there may be a corner that the vehicle cannot travel.

The “corner” in the travel route means not only a bent portion where one passage is bent, but also widely includes portions where the vehicle needs to turn and travel, such as a portion where an intermediate portion of one passage in the length direction is connected to an end portion of another passage (so-called T-intersection), and a portion where two passages intersect with each other (so-called intersection).

The vehicle to be subjected to the traveling control is desirably an autonomously traveling vehicle, and the “traveling control device” can be considered as a controller for realizing autonomous traveling. A vehicle includes various devices related to traveling such as a driving device, a braking device, and a steering device, and the traveling control device can be configured to control these devices. Further, in order to realize autonomous traveling, it is desirable that the vehicle have a function of identifying its own position in the traveling area, such as a GPS function or a beacon detection function.

The vehicle traveling control system may include an operation management device that manages an operation of the vehicle in the traveling area. In this case, the operation management device preferably manages the operation of each of a plurality of vehicles. For example, the operation management device may be configured to create an operation plan of the vehicle and transmit an assignment according to the operation plan to the vehicle. In addition, it is desirable that the operation management device grasp a current position of the vehicle. In a case where the operation management device manages the operation of each of a plurality of vehicles, when one vehicle and another vehicle interfere with each other in traveling, it is desirable that the operation management device have a function of adjusting or arbitrating traveling of at least one of the one vehicle and another vehicle, specifically, for example, a function of giving an instruction such as standby or detour to the one vehicle or another vehicle. In order to realize the transmission of the assignment, the grasping of the current position of the vehicle, the adjustment of the traveling of the vehicle, and the like described above, it is desirable that the operation management device and the vehicle can wirelessly communicate with each other. The determination of the traveling line may be performed by the traveling control device of the vehicle or may be performed by the operation management device. Where the traveling line is determined by the operation management device, the traveling line may be transmitted from the operation management device to the traveling control device of the vehicle.

In the present system, the traveling line may be determined based on nodes set and arranged in the passage. Specifically, for example, a plurality of nodes may be set at a corner, a turning start reference node serving as a reference for the vehicle to start turning and a turning end reference node serving as a reference for the vehicle to end turning may be selected from the plurality of nodes based on the specifications of the vehicle, and an arc-shaped traveling line connecting the turning start reference node and the turning end reference node may be determined.

The “node” means a vertex, a node point, or the like, and can be considered as a point (for example, a virtual point) through which the specific point of the vehicle should pass. The nodes may be arranged not only at corners but also on the entire travel route. For example, in a straight road, the nodes may be arranged linearly along a lane at the center of the lane, and in a corner, the nodes may be arranged such that the straight line extends to the center of the corner. The “turning start reference node” and the “turning end reference node” may be a turning start point and a turning end point themselves, respectively, or may be a reference point for determining the turning start point and a reference point for determining the turning end point, respectively. Specifically, for example, a point that is advanced by a set distance from the turning start reference node may be set as the turning start point, or a point where turning is continued by a set distance from the turning end reference node may be set as the turning end point. As the turning start reference node and the turning end reference node, in general, for example, when turning with a large turning radius is performed, nodes at positions away from the center of the corner may be selected, and when turning with a small turning radius is performed, nodes at positions close to the center of the corner may be selected. The arc-shaped traveling line connecting the turning start reference node and the turning end reference node is not necessarily a part of a perfect circle, and may be substantially arc-shaped. In the present system, data of the nodes may be held at least by a constituent element that determines the traveling line. Where the traveling control device of the vehicle determines the traveling line, the traveling control device may hold the data, and where the operation management device determines the traveling line, the operation management device may hold the data.

The advantages of determining the traveling line using the nodes can be considered as follows. Only by creating one piece of general-purpose node data for each corner, it is possible to select different nodes as the reference nodes for each vehicle based on the specifications of the vehicle with reference to the one piece of node data, and determine the traveling line based on the selected reference nodes. In short, an appropriate traveling line can be determined for each vehicle with one piece of node data. In addition, since it is not necessary to determine the traveling line at the time of turning from information on the surroundings of the vehicle, it is not necessary to intentionally provide a surroundings information acquisition device such as a camera or a LiDAR for the vehicle in order to determine the traveling line.

Regarding the determination of the traveling line at the time of turning, in a case where the travel route includes a bidirectional passage including an own lane and an opposite lane, the following preferable mode is considered. That is, where the corner is a corner from the bidirectional passage to another passage or a corner from another passage to the bidirectional passage, there is a possibility that the traveling line that causes the vehicle to protrude into the opposite lane may be determined depending on the specifications of the vehicle. By adopting such a mode, even a vehicle that makes a turn with a large turning radius can turn a corner with a relatively narrow width. In this regard, it is also possible to determine a traveling line in which the turning start point is different between a right turn and a left turn, that is, a rightward cornering and a leftward cornering, in a turn related to the bidirectional passage.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a schematic diagram showing a traveling area of a vehicle to which a vehicle traveling control system according to an embodiment of the present disclosure is applied;

FIG. 2 is a perspective view of a medium-sized vehicle as an example of a vehicle;

FIG. 3A is a schematic view showing a difference in turning radius among vehicles;

FIG. 3B is a schematic view showing a state of turning of a large-sized vehicle at an intersection;

FIG. 4A is a schematic view showing a state of turning of a medium-sized vehicle at an intersection;

FIG. 4B is a schematic view showing a state of turning of a small-sized vehicle at an intersection;

FIG. 5A is a functional block diagram of an operation management device;

FIG. 5B is a functional block diagram of a traveling control device of the vehicle; and

FIG. 6 is a flowchart of a process for determining a traveling line of a vehicle at a corner.

### DESCRIPTION

Hereinafter, a vehicle traveling control system according to one embodiment of the present disclosure will be described in detail with reference to the drawings as a mode for carrying out the present disclosure. It is to be understood that the present disclosure is not limited to the following embodiment, but may be embodied in various changes and modifications based on the knowledge of those skilled in the art, including the forms described in the foregoing “Various Forms”.

### [A] Vehicle Traveling Area and Vehicle Type

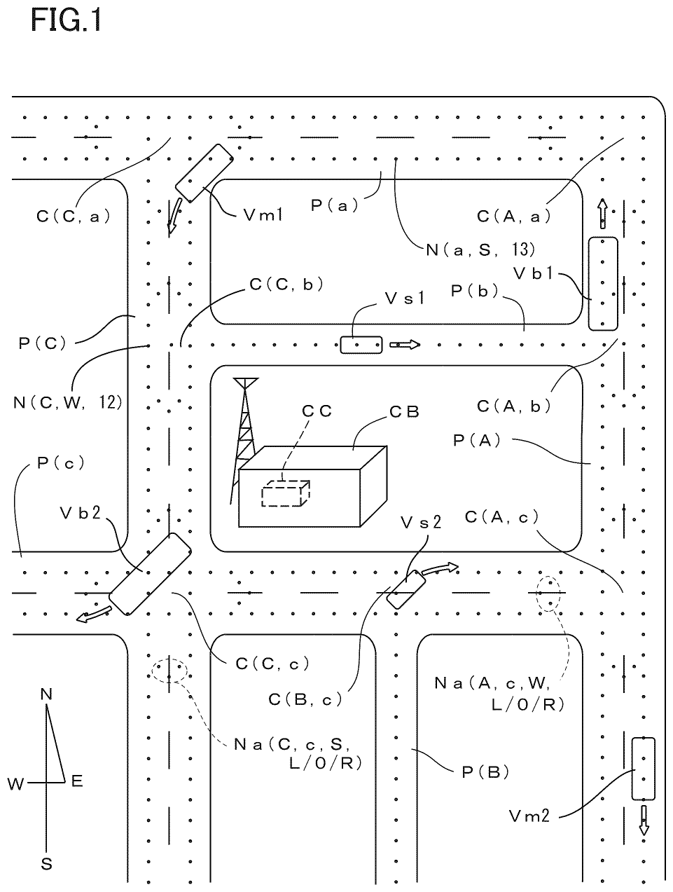

As schematically shown in FIG. 1, a traveling area of a vehicle to which a vehicle traveling control system of the embodiment (hereinafter abbreviated as the “present vehicle traveling control system” or the “present system” where appropriate) is applied is one enterprise space, and passages are arranged in north, south, east, and west in the enterprise space. For convenience, passages extending in the north-south direction are denoted by symbols A, B, C, and ⋅ ⋅ ⋅ in order from the east side, and passages extending in the east-west direction are denoted by symbols a, b, and c ⋅ ⋅ ⋅ in order from the north side. Hereinafter, a passage extending in the north-south direction will be referred to as a passage P (X), and a passage extending in the east-west direction will be referred to as a passage P (x). Where it is not necessary to distinguish the passage (X) and the passage (x) from each other, they are collectively referred to as the passage P. Note that A, B, C, and ⋅ ⋅ ⋅ are substituted for X, and a, b, and c ⋅ ⋅ ⋅ are substituted for x. Incidentally, the passages P (A), P (C), P (a), and P (c) in the drawing are bidirectional passages for left-hand traffic in which vehicles can travel in the opposite direction. In each of the passages P (A), P (C), P (a), and P (c), a center line is drawn at the center, and the passages P (A), P (C), P (a), and P (c) have two lanes (traffic lanes) including an own lane and an opposite lane with the center line interposed therebetween. On the other hand, the passage (B) and the passage (b) are narrow in width, have only one lane, and are one-way roads.

A point where the passage P (X) and the passage P (x) intersect with each other, specifically, a position where an end of one passage P (X) and another passage P (x) are connected to each other, a position where one passage P (X) or P (x) and another passage P (x) or P (X) are connected to each other in a T-shape, and a position where one passage P (X) and another passage P (x) intersect with each other are collectively referred to as a corner C for convenience, and when they are individually represented, they are represented each as a corner C (X, x) using symbols X and x of the intersecting passages P (X) and P (x).

In each passage P, nodes N are arranged at the center of the lane at regular intervals (for example, 1 to 2 m) in a direction in which the passage P extends. Each node N is identified by a symbol X or x of the passage P, a symbol L indicating which lane in the case of a bidirectional passage, and a number * from the end of the passage P. Specifically, in a passage P (X) extending in the north-south direction, the node N is represented as a node N (X, L, *), and in a passage P (x) extending in the east-west direction, the node N is represented as a node N (x, L, *). For L, E is assigned to the east lane while W is assigned to the west lane in the passage P (X) extending in the north-south direction, and N is assigned to the north lane while S is assigned to the south lane in the passage P (x) extending in the east-west direction. If the passage is not a bidirectional passage, L is not used. As the numbers * of the nodes N, 1, 2, 3, and ⋅ ⋅ ⋅ are substituted in order from the north side in the passage P (X) extending in the north-south direction and in order from the east side in the passage P (x) extending in the east-west direction, respectively. In the present system, the nodes N are arranged at equal intervals. However, for example, the intervals of the nodes N may be narrowed at the corner C and the vicinity thereof.

In the bidirectional passage, three auxiliary nodes Na, which are auxiliary nodes, are disposed beside each corner C. The auxiliary node Na is a node used when the vehicle turns left at the corner C, which will be described in detail later. Each auxiliary node Na is represented as Na (X, x, D, #). D indicates in which direction of the corner C the node is arranged, and N, S, E, and W are substituted for the north side, the south side, the east side, and the west side, respectively. For the number #, R is assigned to the right side, L is assigned to the left side, and 0 is assigned to the center, when viewed toward the corner C.

Several types of vehicles travel in the traveling area. For convenience, it is assumed that a relatively large-sized vehicle Vb, a relatively small-sized vehicle Vs, and a medium-sized vehicle Vm having an intermediate size therebetween travel in the present traveling area. The large-sized vehicle Vb is a vehicle having a size of a bus, a truck, or the like, and the small-sized vehicle Vs is a vehicle having a size in which only one person can ride. In the present traveling area, the medium-sized vehicle Vm is a vehicle in which a tractor and a trailer such as a bogie are coupled to each other, as will be described in detail later. When it is not necessary to distinguish the large-sized vehicle Vb, the medium-sized vehicle Vm, and the small-sized vehicle Vs, they are collectively referred to as a vehicle V. Numbers & are given to the large-sized vehicle Vb, the medium-sized vehicle Vm, and the small-sized vehicle Vs, respectively, and the large-sized vehicle Vb, the medium-sized vehicle Vm, and the small-sized vehicle Vs are represented as Vb&, Vm&, and Vs&, respectively. Incidentally, 1, 2, 3, and ⋅ ⋅ ⋅ are substituted into &.

In the drawing, there are illustrated a state in which a large-sized vehicle Vb1 is traveling straight toward the north on the passage P (A), a state in which a large-sized vehicle Vb2 is turning right at a corner C (C, c), a state in which a medium-sized vehicle Vm1 is turning left at a corner C (C, a), a state in which a medium-sized vehicle Vm2 is traveling straight toward the south on the passage P (A), a state in which a small-sized vehicle Vs1 is traveling straight toward the east on the passage P (b), and a state in which a small-sized vehicle Vs2 is turning right at a corner C (B, c). It should be noted that it is difficult for the large-sized vehicle Vb and the medium-sized vehicle Vm to enter the passage P (B) and the passage P (b) by turning left and to get out of the passage P (B) and the passage P (b) by turning left in relation to a turning radius or the like. Therefore, only the small-sized vehicle Vs can pass through the passage P (B) and the passage P (b), that is, the one-way passage P having only one lane.

### [B] Configuration of Vehicle

As described above, the vehicles to which the present system is applied are three types of vehicles, that is, the large-sized vehicle Vb, the medium-sized vehicle Vm, and the small-sized vehicle Vs for convenience. Each of the large-sized vehicle Vb and the small-sized vehicle Vs is a four-wheeled vehicle whose front wheels are steerable wheels. The configuration of each of the large-sized vehicle Vb and the small-sized vehicle Vs is general, and thus description thereof is omitted here.

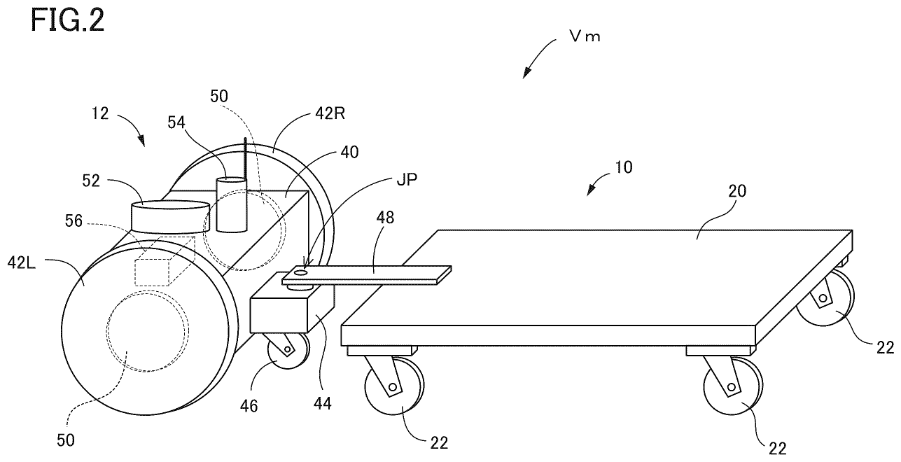

As shown in FIG. 2, the medium-sized vehicle Vm includes a trailer 10 and a tractor 12 that tows the trailer 10. The trailer 10 includes a base plate 20 and four casters 22 attached to an underside of the base plate 20. The side towed by the tractor 12 is a front side, and the opposite side is a rear side. The four casters 22 include a pair of left and right casters 22 disposed on the front side and a pair of left and right casters 22 disposed on the rear side. The two casters 22 on the front side are swivel casters, and the orientation thereof is freely changed. On the other hand, the orientation of the two casters 22 on the rear side is fixed in the front-rear direction.

The tractor 12 includes a vehicle body 40 having a substantially rectangular parallelepiped external shape, and a left drive wheel 42L and a right drive wheel 42R, which are a pair of left and right drive wheels 42. A coupler 44 is attached to a rear portion of the vehicle body 40, and an auxiliary wheel 46 for making the tractor 12 stand by itself is provided in the form of a swivel caster below the coupler 44. That is, the tractor 12 does not have steerable wheels that are actively steered. A coupling bar 48 is fixed to the base plate 20 of the trailer 10. When the front end of the coupling bar 48 is coupled to the coupler 44, the trailer 10 is coupled to the tractor 12 via the coupler 44 such that the trailer 10 and the tractor 12 are rotatable relative to each other. Specifically, in a state in which the tractor 12 and the trailer 10 are coupled to each other, the tractor 12 and the trailer 10 are allowed to freely rotate relative to each other in a substantially horizontal direction about a coupling point JP in the coupler 44.

The left drive wheel 42L and the right drive wheel 42R of the tractor 12 are driven independently of each other by respective electric motors 50, which are in-wheel motors. By rotating the left drive wheel 42L and the right drive wheel 42R at the same speed, the tractor 12 moves straight forward or backward. The tractor 12 turns by providing a speed difference between the rotations of the left drive wheel 42L and the right drive wheel 42R. Incidentally, by rotating the left drive wheel 42L and the right drive wheel 42R in opposite directions at the same speed, the tractor 12 can perform a super-pivot turn. Braking of the tractor 12, that is, braking of the left drive wheel 42L and the right drive wheel 42R, is also performed by regenerative braking or reverse braking by the electric motors 50.

As shown in FIG. 1, in the present system, an operation management device CC that manages operations of a plurality of vehicles V is provided in a management building CB, and the tractor 12 performs unmanned traveling, that is, autonomous traveling, based on a command from the operation management device CC. A general method may be adopted as a method of autonomous traveling, and a description thereof is omitted here. However, for autonomous traveling, the tractor 12 includes a camera, a positioning sensor (GPS sensor), a yaw rate sensor, an acceleration sensor, wheel speed sensors, and the like in a sensor box 52 attached to an upper portion of the vehicle body 40, and includes a communication device 54. The tractor 12 incorporates a controller 56, a power supply, and the like for autonomous traveling in the vehicle body 40.

Like the tractor 12, the large-sized vehicle Vb and the small-sized vehicle Vs also include a sensor box, a communication device, a controller, a power supply, and the like in order to autonomously travel. It should be noted that the controllers of the large-sized vehicle Vb, the medium-sized vehicle Vm and the small-sized vehicle Vs are mounted on the respective vehicles V and function as travel controlling devices that control traveling of the respective vehicles V.

### [C] Vehicle Turning at Corner

An appropriate turning radius is set when the vehicle V turns the corner C in the traveling area. In the large-sized vehicle Vb and the small-sized vehicle Vs, a turning limit of the steerable wheels is set by the length, the width, the wheelbase, the inner wheel difference, the outer wheel difference, and the like of the vehicle, and a minimum turning radius is determined based on the setting. An appropriate turning radius is set based on the minimum turning radius. In the medium-sized vehicle Vm, if only the tractor 12 is used, the super-pivot turn is possible. However, when the trailer 10 is towed, a certain turning radius is required in consideration of a so-called jackknife phenomenon or the like. Therefore, an appropriate turning radius is set.

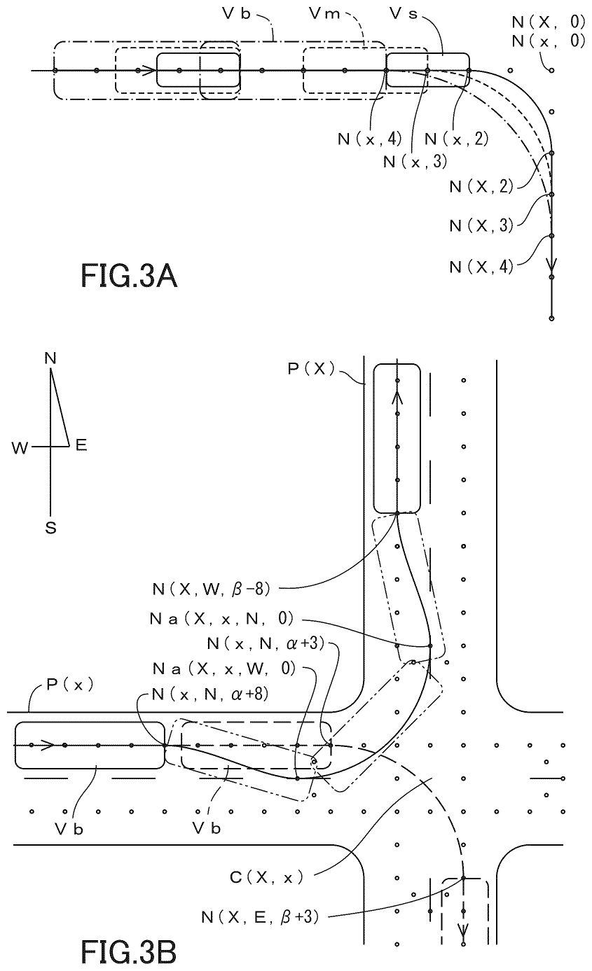

When the appropriate turning radius is compared among the large-sized vehicle Vb, the medium-sized vehicle Vm, and the small-sized vehicle Vs, the result is shown in FIG. 3 A. FIG. 3A illustrates a state in which the vehicle V turns so as to turn at a right angle. A solid line indicates turning of the small-sized vehicle Vs, a broken line indicates turning of the medium-sized vehicle Vm, and a one-dot chain line indicates turning of the large-sized vehicle Vb. For ease of understanding, nodes N are arranged in the left-right direction and the up-down direction in the drawing. When described based on the nodes N, according to turning with the appropriate turning radius, the small-sized vehicle Vs turns with a node N (x, 2) as the turning start point and a node N (X, 2) as the turning end point, the medium-sized vehicle Vm turns with a node N (x, 3) as the turning start point and a node N (X, 3) as the turning end point, and the large-sized vehicle Vb turns with a node N (x, 4) as the turning start point and a node N (X, 4) as the turning end point.

For convenience, in the following description, the position of the turning start point is treated as the position of a turning start reference node Ns, and the position of the turning end point is treated as the position of a turning end reference node Ne. In this way, any vehicle V turns substantially along an arc-shaped traveling line connecting the turning start reference node Ns and the turning end reference node Ne. In actual turning, the turning start point may be set, for example, at a position near the turning start reference node Ns based on the turning start reference node Ns, the turning end point may be set, for example, at a position near the turning end reference node Ne based on the turning end reference node Ne, and the vehicle V may turn along an arc-shaped traveling line connecting the turning start point and the turning end point. For the sake of convenience, such a traveling line is also treated as the arc-shaped traveling line connecting the turning start reference node Ns and the turning end reference node Ne. For the sake of convenience, the traveling line is treated as a line traced by the center point of the front end of the vehicle V.

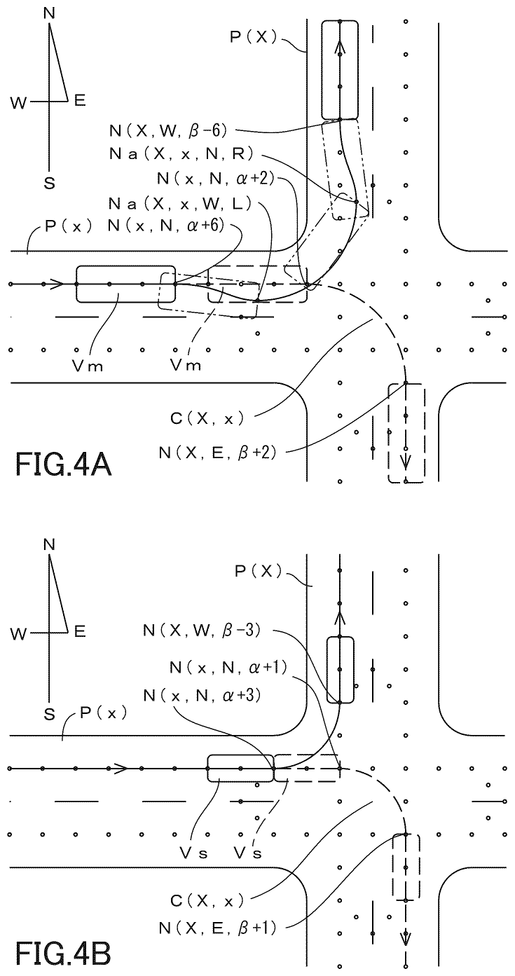

On the premise of the above, turning at a corner C (X, x), which is an intersection of a bidirectional passages, will be described with reference to FIGS. 3B, 4A, and 4 B. FIG. 3B shows turning of the large-sized vehicle Vb, FIG. 4A shows turning of the medium-sized vehicle Vm, and FIG. 4B shows turning of the small-sized vehicle Vs. Each of the drawings shows a state of turning right and a state of turning left from the passage P (x) to the passage (X). The vehicle V turning right and its traveling line are indicated by broken lines, and the vehicle V turning left and its traveling line are indicated by solid lines.

First, turning of the small-sized vehicle Vs will be described with reference to FIG. 4B. The small-sized vehicle Vs has a relatively small turning radius and a relatively small inner wheel difference. Therefore, in the case of a right turn, the turning start reference node Ns is set to a node N (x, N, α+1), and the turning end reference node Ne is set to a node N (X, E, β+1). The small-sized vehicle Vs turns along an arc-shaped traveling line connecting the node N (x, N, α+1) and the node N (X, E, β+1). Similarly, in the case of a left turn, the turning start reference node Ns is set to a node N (x, N, α+3), and the turning end reference node Ne is set to a node N (X, W, β−3). The small-sized vehicle Vs turns along an arc-shaped traveling line connecting the node N (x, N, α+3) and the node N (X, W, β−3). Incidentally, a and B are specific numbers indicating the center of the corner C (X, x).

In the case of the medium-sized vehicle Vm, the turning radius is large to some extent. Accordingly, as shown in FIG. 4A, in the case of a right turn, the turning start reference node Ns is set to a node N (x, N, α+2), and the turning end reference node Ne is set to a node N (X, E, β+2). The medium-sized vehicle Vm turns along an arc-shaped traveling line connecting the node N (x, N, α+2) and the node N (X, E, β+2). On the other hand, in the medium-sized vehicle Vm, since the inner wheel difference is large to some extent, if the vehicle turns normally, the vehicle body protrudes into the turning inner side when turning left. Therefore, in the present system, in the case of a left turn, as indicated by a two-dot chain line in the drawing, the medium-sized vehicle Vm is once shifted toward the center of the passage, then starts turning at an appropriate turning radius, and returns to the center of the lane after the turning is completed. Incidentally, the shift means a change in position in the width direction of the passage. Specifically, a shift start reference node Ns' is set to a node N (x, N, α+6), the turning start reference node Ns is set to an auxiliary node Na (X, x, W, L), the turning end reference node Ne is set to an auxiliary node Na (X, x, N, R), and a shift end reference node Ne′ is set to a node N (X, W, β−6). The medium-sized vehicle Vm shifts to the right from the node N (x, N, α+6) to the auxiliary node Na (X, x, W, L), turns along an arc-shaped traveling line connecting the auxiliary node Na (X, x, W, L) and the auxiliary node Na (X, x, N, R), and shifts to the left from the auxiliary node Na (X, x, N, R) to the node N (X, W, β−6).

In the case of the large-sized vehicle Vb, the turning radius is larger. Therefore, as shown in FIG. 3B, in the case of a right turn, the turning start reference node Ns is set to a node N (x, N, α+3), and the turning end reference node Ne is set to a node N (X, E, β+3). The large-sized vehicle Vb turns along an arc-shaped traveling line connecting the node N (x, N, α+3) and the node N (X, E, β+3). In the case of the large-sized vehicle Vb, the inner wheel difference is larger. Therefore, in the case of the left turn, the large-sized vehicle Vb shifts by a larger amount to perform the left turn. Specifically, the shift start reference node Ns' is set to a node N (x, N, α+8), the turning start reference node Ns is set to an auxiliary node Na (X, x, W, 0), the turning end reference node Ne is set to an auxiliary node Na (X, x, N, 0), and the shift end reference node Ne′ is set to a node N (X, W, β−δ). The large-sized vehicle Vb shifts to the right from the node N (x, N, α+8) to the auxiliary node Na (X, x, W, 0), turns along an arc-shaped traveling line connecting the auxiliary node Na (X, x, W, 0) and the auxiliary node Na (X, x, N, 0), and shifts to the left from the auxiliary node Na (X, x, N, 0) to the node N (X, W, β−8). In such a left turn, the large-sized vehicle Vb protrudes into the opposite lane, and in the present system, such protrusion is allowed for the large-sized vehicle Vb.

### [D] Operation Management Device, Function of Vehicle Traveling Control Device, and Determination of Traveling Line

### i) Function of Operation Management Device

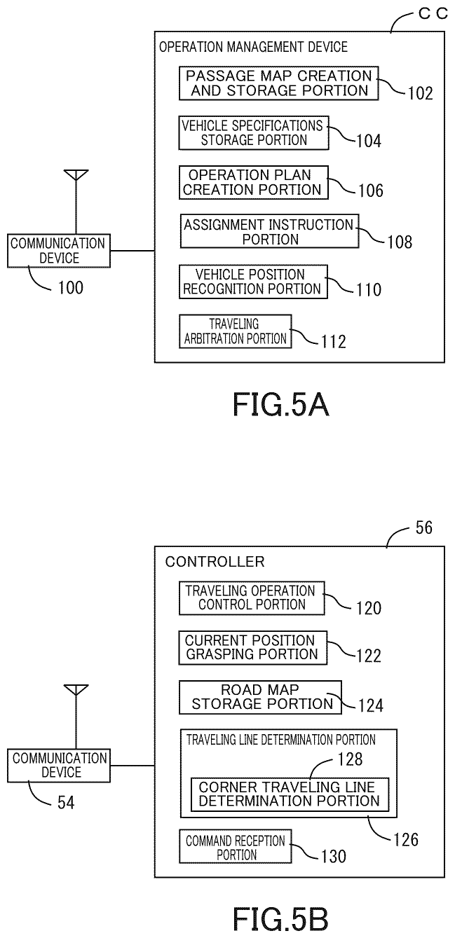

The operation of the vehicle V is performed by the operation management device CC described above. The operation management device CC is a device including a computer as a main component. FIG. 5A shows a functional block diagram of the operation management device CC. Each block shown in this figure is a functional block realized by the computer executing a predetermined program. Hereinafter, the function of the operation management device CC will be described with reference to this block diagram. The management building CB includes a communication device 100, and the operation management device CC manages the operation of the vehicle V via the communication device 100.

The operation management device CC includes a passage map creation and storage portion 102. The passage map creation and storage portion 102 creates a passage map by setting the nodes N and the auxiliary nodes Na in the passages P (X) and P (x) and the corners C (X, x), and stores the passage map. The information on the passage map is transmitted to each vehicle V via the communication device 100 each time the information is created. In addition, the operation management device CC includes a vehicle specifications storage portion 104 that stores the specifications of each vehicle V, and grasps the specifications of each vehicle V, that is, what kind of vehicle each vehicle V is.

The operation management device CC includes an operation plan creation portion 106. The operation plan creation portion 106 creates an operation plan of each vehicle V. The operation plan can be considered as a list indicating, for each vehicle V, when and what kind of operation is performed by the vehicle V. In addition, the operation management device CC includes an assignment instruction portion 108. The assignment instruction portion 108 has a function of instructing a vehicle that has finished one job to perform a next job, that is, a next assignment based on the operation plan. The assignment includes a travel route and a destination. Specifically, the assignment includes information indicating which of the passages P (X) and P (x) the vehicle passes through, information indicating which of the corners C (X, x) the vehicle turns right or left, information indicating to which node N the vehicle travels as the destination, and the like. When one vehicle V finishes one assignment, the next assignment is transmitted to the vehicle V via the communication device 100.

As will be described later, each vehicle V grasps its own position. Specifically, each vehicle V always grasps which node N the vehicle has passed and always transmits information on the passed node N. The operation management device CC has a vehicle position recognition portion 110. The vehicle position recognition portion 110 acquires the information via the communication device 100 and recognizes the position of each vehicle V at the current time point and the traveling direction in a case where the vehicle V is traveling. The operation management device CC includes a traveling arbitration portion 112. To avoid interference between one vehicle V and other vehicle V, the traveling arbitration portion 112 adjusts traveling of at least one of the one vehicle V and other vehicle V based on the current position and the traveling direction of each vehicle V. Specifically, the traveling arbitration portion 112 always transmits, for example, a command to decelerate, temporarily stop, overtake the stopped vehicle V, or detour to another route to at least one of the one vehicle V and other vehicle V via the communication device 100.

The controller 56 included in each vehicle V is a traveling control device of each vehicle V. The controller 56 includes a computer as a main component and also includes drivers (drive circuits) of the driving device, the braking device, and the steering device. FIG. 5B shows a functional block diagram of the controller 56. Each block shown in this figure is a functional block realized by the computer executing a predetermined program. Hereinafter, the functions of the controller 56 will be described with reference to this block diagram.

### ii) Functions of Controller Provided in Vehicle

A main function of the controller 56 is a function of controlling the traveling operation of the vehicle V itself by controlling the driving device, the braking device, the steering device, and the like included in the vehicle V. In order to realize the function, the controller 56 includes a traveling operation control portion 120. In order to grasp the current position of the vehicle V in the control of the traveling operation, the controller 56 includes a current position grasping portion 122. The controller 56 includes a passage map storage portion 124. The passage map storage portion 124 stores a passage map in which the nodes N are arranged based on the information transmitted from the operation management device CC. The current position grasping portion 122 grasps the current position of the vehicle V by grasping which node N the vehicle V has passed through based on the passage map and the position detection information of the GPS device described above. The current position is transmitted to the operation management device CC via the communication device 54.

The controller 56 includes a traveling line determination portion 126. The traveling line determination portion 126 determines a traveling line along which the vehicle V is to travel in order to execute the assignment, so as to connect the nodes N based on the assignment transmitted from the operation management device CC. The traveling line determination portion 126 includes a corner traveling line determination portion 128 as a notable functional portion. As described above, the corner traveling line determination portion 128 determines the turning start reference node Ns and the turning end reference node Ne at the corner C (X, x), and in some cases, the shift start reference node Ns' and the shift end reference node Ne′, based on the specifications of the vehicle V, so as to determine the traveling line at the time of turning. The traveling operation control portion 120 described above controls the driving device, the braking device, the steering device, and the like such that the vehicle V travels along the traveling line determined by the traveling line determination portion 126.

In addition, the controller 56 includes a command reception portion 130 in order to receive an assignment that is a prerequisite for creating the traveling line and the above-described traveling arbitration information via the communication device 54. Based on the received information, the traveling line determination portion 126 determines the traveling line, and the traveling operation control portion 120 controls the traveling operation of the vehicle V.

iii) Flow for Determining Corner Traveling Line

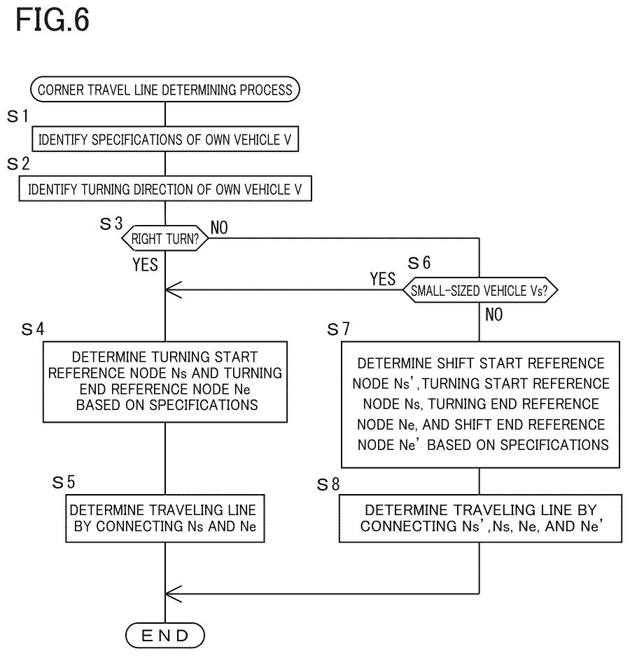

Processing for determining the traveling line at the corner C will be briefly described below with reference to the flowchart of FIG. 6. This flowchart can be considered to indicate a type of determination of the corner traveling line based on the specifications of the vehicle V. The processing according to the flowchart is performed when the vehicle approaches the corner C to some extent.

In the processing according to the flowchart, first, step 1 (hereinafter abbreviated as “S1” and other steps will be similarly abbreviated) is performed. In S1, the specifications of an own vehicle V are identified, that is, whether the own vehicle V is the small-sized vehicle Vs, the medium-sized vehicle Vm, or the large-sized vehicle Vb is identified. Subsequently, in S2, the turning direction of the own vehicle V at the corner C, that is, whether the own vehicle V turns right or left, is identified.

When it is determined in S3 that the own vehicle V turns right, the turning start reference node Ns and the turning end reference node Ne are determined in S4 based on the specifications of the own vehicle V as described above. Then, in S5, an arc-shaped traveling line connecting the turning start reference node Ns and the turning end reference node Ne is determined.

When it is determined in S3 that the own vehicle V turns left, it is determined in S6 whether or not the own vehicle V is the small-sized vehicle Vs. When the own vehicle Vis the small-sized vehicle Vs, the turning start reference node Ns and the turning end reference node Ne for the small-sized vehicle Vs are determined in S4, and an arc-shaped traveling line connecting the turning start reference node Ns and the turning end reference node Ne is determined in S5.

When the vehicle V is the medium-sized vehicle Vm or the large-sized vehicle Vb, the shift start reference node Ns′, the turning start reference node Ns, the turning end reference node Ne, and the shift end reference node Ne′ suitable for the medium-sized vehicle Vm or the large-sized vehicle Vb are determined in S7 as described above. In S8, a traveling line connecting the shift start reference node Ns′, the turning start reference node Ns, the turning end reference node Ne, and the turning end reference node Ne′ is determined.

### iv) Modification of Determination of Traveling Line

In the system of the present embodiment, the traveling line is determined by the controller 56 of the vehicle V. However, the system may be configured such that the traveling line is determined by the operation management device CC. The operation management device CC may determine the traveling line according to the above-described processing and transmit information on the determined traveling line and information on the turning start reference node Ns, the turning end reference node Ne, and the like to the vehicle V.

What is claimed is:

1. A vehicle traveling control system installed on a vehicle and comprising a traveling control device configured to control traveling of the vehicle,
wherein a traveling line, along which the vehicle is to travel when the vehicle turns a corner in a travel route, is determined based on specifications of the vehicle, and the traveling control device is configured to cause the vehicle to turn along the traveling line.

2. The vehicle traveling control system according to claim 1, further comprising an operation management device that manages an operation of the vehicle,
wherein the operation management device is configured to determine the traveling line.

3. The vehicle traveling control system according to claim 1,
wherein a plurality of nodes are set at the corner,
wherein a turning start reference node serving as a reference for the vehicle to start turning and a turning end reference node serving as a reference for the vehicle to end turning are selected from the plurality of nodes based on the specifications of the vehicle, and
wherein an arc-shaped traveling line connecting the turning start reference node and the turning end reference node is determined.

4. The vehicle traveling control system according to claim 1,
wherein the travel route includes a bidirectional passage including an own lane and an opposite lane,
wherein, where the corner is a corner from the bidirectional passage to another passage or a corner from another passage to the bidirectional passage, there is a possibility that the traveling line that causes the vehicle to protrude into the opposite lane is determined depending on the specifications of the vehicle.

5. The vehicle traveling control system according to claim 1, wherein the specifications of the vehicle on which the determination of the traveling line is based include a turning radius of the vehicle.
